(19) United States
(12) Patent Application Publication
(10) Pub. No.: US 2008/0139696 A1
(43) Pub. Date: Jun. 12, 2008

(54) DRAG REDUCING COMPOSITIONS AND METHODS OF MANUFACTURE AND USE

(76) Inventors: Brad A. Bucher, Houston, TX (US); Michael J. Monahan, Katy, TX (US); Steven B. Erikson, Houston, TX (US)

Correspondence Address: C. JAMES BUSHMAN, 5718 WESTHEIMER, SUITE 1800, HOUSTON, TX, 77057, US

(21) Appl. No.: 11/951,750

(22) Filed: Dec. 6, 2007

Related U.S. Application Data
(60) Provisional application No. 60/873,687, filed on Dec. 8, 2006.

(51) Int. Cl. B05D 5/08

(52) U.S. Cl. 523/175

(57) ABSTRACT

A drag reducing composition containing a finely divided solid polyolefin friction-reducing agent formed from mono olefins containing from 2 to 3 carbon atoms, a fatty acid suspending medium and a modifier which is an oxygenated polar organic compound containing from 1 to 20 carbon atoms, water or mixtures thereof.

### CROSS REFERENCE TO RELATED APPLICATION

This application claims the priority of U.S. Provisional Application No. 60/873,687 filed on Dec. 8, 2006, the disclosure of which is incorporated herein by reference for all purposes.

### BACKGROUND OF THE INVENTION

1. Field of the Invention

The present invention relates to compositions for reducing friction in the flow of hydrocarbons such as crude oil or refined products in conduits such as pipelines, and to methods for producing and using such compositions.

2. Description of the Prior Art

The prior art abounds with patents directed to generally non-crystalline, high molecular weight polyolefin, particularly polyalphaolefins, compositions which are generally hydrocarbon soluble and, when dissolved in a hydrocarbon fluid flowing through a conduit, greatly reduce turbulent flow and decrease “drag.” This reduction of drag is important since it reduces the amount of horsepower needed to move a given volume of hydrocarbon, or conversely enables greater volumes of fluid to be moved with a given amount of power. These polyolefin drag reducers display flow enhancing characteristics not present in commonly known crystalline, largely non-hydrocarbon soluble polymers such as polyethylene and polypropylene.

It is known that these polyalphaolefin drag reducers are susceptible to degradation by shear when dissolved in the flowing hydrocarbon in the conduit. Accordingly, pumps, constrictions in the conduit or the like which result in excessive turbulent flow lead to degradation of the polymer thereby decreasing its effectiveness. Accordingly, it is necessary that the drag reducing compositions be introduced into the flowing hydrocarbon stream in a form which achieves certain desirable features.

First of all, the drag reducing compositions should be in a form that is easy to transport and handle without special equipment since injection points for the drag reducing compositions into the flowing hydrocarbon stream are often at remote and inaccessible locations. Secondly, the polymer must be in a form which dissolves rapidly in the hydrocarbon stream flowing in the conduit since the polyalphaolefins have little drag reducing effect until solubilized in the hydrocarbon stream. Lastly, the drag reducing composition should impart no deleterious effects to the hydrocarbon. For example, in the case of crude oil flowing through a pipeline, certain amounts of material and contaminants can be tolerated unlike in finished pipeline products such as diesel fuel, gasoline and other hydrocarbon materials resulting from refining operations.

A number of approaches have been taken in the preparation of drag reducing compositions. For example, because of the effectiveness of the polyolefins as drag reducers, solutions of the polyalphaolefins ranging from one up to 100 parts per million can be employed in drag reduction. Accordingly in the case of a solution produced polyalphaolefin wherein alphaolefin is polymerized in a dilute solution of an inert solvent such as hexane, isopentane or the like, the entire mixture containing polyolefin, solvent and catalyst can be used without separation to form dilute solutions of the polymer in the crude oil or finished hydrocarbon. The disadvantage of this approach is that the inert solvent, which is a hydrocarbon, is flammable and poses shipping and handling problems. Furthermore, the product generally is a gel-like substance and difficult to introduce into a flowing hydrocarbon streams. Moreover, in cold weather conditions the gel becomes extremely viscous and difficult to handle making injection difficult and often requiring special equipment.

It is also known from U.S. Pat. Nos. 4,584,244, 4,720,397, 4,826,728, and 4,837,249 to prepare the polyolefin drag reducing polymers as a solid material and grind the solid polyolefins to a very small particle size in an inert atmosphere below the glass transition point of the polymers and in the presence of a partitioning or coating agent which coats the polymer particles. Thus it is taught to prepare the fine particle size polyolefins in an inert atmosphere utilizing a refrigerant such as liquid nitrogen and a coating agent while grinding the polyolefin polymers to the desired particle size, the coating agent preventing contact of oxygen with the freshly ground polymer particles and their reagglomeration at more elevated, usable temperatures.

U.S. Pat. No. 6,172,151 is directed to the formation of a drag reducing composition containing a polyolefin formed from olefins containing from 2 to 30 carbon atoms, the composition comprising a partitioning agent which is a fatty acid wax which is used during the cyrogrinding of the polymer. The polymer particles, coated with the fatty acid wax partitioning agent are then suspended in a suspending agent which is an alcohol containing 14 or less carbon atoms, a glycol containing 14 or less carbon atoms, mixtures of such alcohols and glycols, dipropylene glycol methyl ether, tripropylene glycol methyl ether, tetrapropylene glycol methyl ether, ethyl ethers and mixtures of such ethers. In any event, the suspending medium is “substantially free of water, the water level generally being below 1 to 2%”.

### SUMMARY OF THE INVENTION

The present invention provides a drag reducing composition which can exhibit freeze protection, permits a relatively high loading of active polyolefin in the composition, eliminates agglomeration and heat instability problems and, in some embodiments, can eliminate concerns about adding water to product pipelines.

In one embodiment of the present invention, there is provided a drag reducing composition containing from 10 to 70% by weight of a finely divided solid polyolefin friction reducing agent obtained by polymerizing olefins containing from 2 to 30 carbon atoms and from 10 to 65% by weight of a fatty acid suspending medium and from 0.1 to 80% by weight of a modifier comprising an oxygenated, polar organic compound, water and mixtures of such polar organic compounds and water.

Another aspect of the invention is a method of forming a drag reducing composition which comprises finely dividing a solid polyolefin friction reducing agent formed from olefins containing from 2 to 30 carbon atoms to produce a free flowing particulate polyolefin material and suspending the particulate polyolefin material in a mixture of a suspending medium comprising a fatty acid and a modifier as described above.

In still another aspect of the present invention, there is provided a method of reducing drag in a conduit conveying a liquid hydrocarbon comprising introducing into the conduit an effective amount of the drag reducing composition described above.

### DESCRIPTION OF THE PREFERRED EMBODIMENTS

Polymers which are used to prepare the finely divided polymer particles used in the drag reducing compositions of the present invention are obtained by polymerizing or copolymerizing mono-olefins from about 2 to about 30 carbon atoms. More usually, the mono-olefins, which are preferably alpha olefins, used in the preparation of the friction-reducing polymers used in the drag reducing compositions of the present invention contain from about 4 to about 20 carbon atoms, most preferably from about 6 to about 10 carbon atoms.

Any of several well known methods for polymerizing the mono-olefins may be employed to produce the polymeric/co-polymeric friction-reducing agents used in the drag reducing compositions of the present invention. A particularly suitable method is the Ziegler process which employs a catalyst system comprising the combination of a compound of a metal of Groups IVb, Vb, VIb, or VIII of the Periodic Chart of Elements, with an organo metal compound of a rare earth metal or a metal from Groups Ia, IIa, and IIIb of the Periodic Chart of the Elements. Particularly suitable catalyst systems are those comprising titanium halides and organo aluminum compounds. A typical polymerization procedure is to contact the monomeric mixture with a catalyst in a suitable inert hydrocarbon solvent for the monomers and the catalyst in a closed reaction vessel at reduced temperatures autogenous pressure and in a nitrogen or inert atmosphere. Methods and catalysts used in the preparation of polyolefin drag-reducing polymers useful in the present invention are disclosed in the following U.S. Pat. Nos. 4,289,679; 4,358,572; 4,415,704; 4,433,123; 4,493,903; and 4,493,904, all of which are incorporated herein by reference. Polyalphaolefins used in the drag reducing compositions of the present invention can be produced by a so-called solution polymerization technique, or by bulk polymerization methods.

The polymers which are used in preparing the drag reducing compositions of the present invention are generally those of high molecular weight, the only limitation on the molecular weight being that it must be sufficient to provide effective friction reduction in the flowing stream of hydrocarbon in a conduit. In general, the effectiveness of the polymer composition to reduce friction increases as the molecular weight increases. On the upper end of the scale, the molecular weight of the polymers used in the process of the invention is limited only by the practicability of making the polymers. The average molecular weight of the desirable polymers is usually over 100,000 and is generally in the range of from about 100,000 to about 20 million. The average molecular weight of the polymers used in the processes and compositions of the present invention is preferably in the range of about 500,000 to about 30 million.

Generally speaking, the drag reducing compositions of the present invention will contain from about 10 to 70%, preferably 25 to 60% by weight of the polyolefin produced as described above, be it a solution polymerized or bulk polymerized polymer.

In addition to the polyolefin friction reducing agent, the drag reducing compositions of the present invention can contain a coating agent, e.g., a wax. The term “wax” includes any low melting organic mixture or compound of high molecular weight which is solid at ambient temperature. The waxes contemplated by the present invention can be natural, i.e., derived from animal, vegetable or mineral sources, e.g., fatty acid waxes, or synthetic as, for example, ethylenic polymers, waxes obtained from the Fischer-Tropsch synthesis, etc. Non-limiting examples of suitable waxes include paraffin, micro-crystalline wax, slack or scale wax, polymethylene wax, polyethylene wax, fatty acid wax, etc. Typically, the waxes used in the compositions of the present invention are hydrocarbon in nature and are powders or particulates at room temperature. In addition to waxes, non-limiting examples of other suitable coating agents include talc, alumina, metal sterates, silica gel, polyanhydride polymers, etc.

Generally speaking and when used, the coating agent will be present in the compositions of the present invention in an amount of from about 0.1 to about 25% by weight.

In addition to the polyolefin, the compositions of the present invention comprise a suspending medium comprising a fatty acid, and a modifier comprising an oxygenated, polar organic compound containing from 1 to 20 carbon atoms, water, and mixtures thereof.

The oxygenated, polar organic compound can comprise a wide variety of oxygenated organic compounds, preferably the polar organic compound or mixture thereof or with water is a stable liquid in the composition in a temperature range of about 10° to about 100° C. wherein “stable liquid” means that the polar organic compound or mixture thereof remains liquid in the composition in at least a region of that temperature range and does not undergo any substantial thermal degradation to the point which would deleteriously affect the composition. Non-limiting examples of such polar organic compounds include alcohols, glycols, ethers, ketones, carboxylic acids including their anhydride, aldehydes, esters, etc. As noted, the polar organic compound can contain from 1 to 20 carbon atoms preferably provided, as stated above, that it is a stable liquid.

A preferred group of polar organic compounds useful in the composition of the present invention comprise alcohols and glycols, particularly alcohols and glycols containing from 1 to 14 carbon atoms, preferably from about 1 to about 8 carbon atoms. Specific, non-limiting examples of such alcohols and glycols include methanol, ethanol, propyl alcohols, butyl alcohols, hexyl alcohols, ethylene glycol, propylene glycol, trimethylene glycol, glycerol, etc., as well as alcohols and glycols which contain ether linkages.

The modifier is generally present in the composition of the present invention in an amount of from about 0.1 to about 80% wt., preferably from about 0.1 to about 20% wt., more preferably from about 0.1 to about 10% wt.

The suspending medium comprises a fatty acid or mixtures thereof. As in the case of the polar organic oxygenated compounds, the suspending medium which can contain one or more fatty acids is preferably a stable liquid in the temperature range of from about 10 to about 100° C. wherein stable liquid has the same meaning as defined above with respect to the modifier, e.g., the polar organic compound. Both in the case of the polar organic compound and the fatty acid component, it is desirable that they be of a type which can be handled safely in terms of flammability, toxicity, etc. Accordingly, it will be recognized, particularly with respect to the polar organic compounds, that certain compounds while operable for their intended purpose in the composition of the present invention are undesirable because of safety and/or health concerns.

The fatty acid component of the suspending medium is typically a vegetable oil, e.g., an oil extracted from the seeds, fruit or nuts of plants. It will be understood that such vegetable oils commonly contain substantial amounts of mixed glycerides as well as long chain fatty acids and it is intended that the term fatty acid encompass the glycerides thereof as well. Non-limiting examples of suitable vegetable oils that can be used as the fatty acid component of the suspending medium include soybean oil, cottonseed oil, linseed oil, corn oil, olive oil, peanut oil, perella oil, etc. It is contemplated that the fatty acid suspending medium can include pure fatty acids as well as mixtures of various fatty acid compositions, i.e., mixtures of various vegetable oils.

The suspending medium can be present in the composition of the present invention in an amount of from about 10 to 65% by weight.

It appears that the use of the fatty acid suspending medium in combination with the modifier provides a synergistic result in the sense that there is reduced settling or separation of the polymer particles from the suspending medium even after the composition is quiescent for a relatively long period of time.

In one method of preparing the compositions of the present invention, the drag reducing polymeric agent is ground at cyrogenic temperatures to produce a finely divided free flowing particulate polyolefin material. The term “cyrogenic temperatures” means temperatures below the glass transition temperature of the polymer or copolymers which are being subjected to grinding. For example, when the polyolefin friction-reducing agent is a high molecular weight poly (1-decene), the cyrogenic temperature is below about −60° C. The temperature employed in carrying out the grinding operation can vary depending on the glass transition point of the particular polymer or polymers used. However, such temperatures must be below the lowest glass transition point of the polymer. Any commercial grinders which are capable of producing finely subdivided particles from solids may be used in producing the free flowing, particulate polyolefin material. Examples of suitable grinders include impact mills, rod mills, ball mills, and the like. The particle size of the resulting particulate polyolefin material can be controlled by methods well known in the art such as by varying the grinding speed, controlling the time of grinding, employing a grinding aid, etc. Techniques for cyrogrinding drag reducing particulate polyolefins are disclosed in U.S. Pat. Nos. 4,837,249; 4,826,728; 4,789,383, all of which are incorporated herein by reference. Depending upon the storage, handling and transportation temperatures to which the friction reducing compositions of the present invention are subjected, it may not be necessary, as noted above, to include a coating agent. However, generally speaking a coating agent will be employed and in this regard the present invention contemplates that at least a part of the coating agent may be added as part of the cyrogrinding step. Alternatively, the polymer can be cyroground in the absence of any coating agent and the coating agent and cyroground polymer added separately to the fatty acid suspending medium. Thus, for example, cyroground poly alpha olefins friction reducing agent could be added to the suspending medium together with wax or some other coating agent. Indeed, it has been found that a stable non-agglomerating composition can be achieved in this manner. However, in the usual case, the cyrogrinding of the poly alpha olefin will occur in the presence of at least a portion of the coating agent, the remainder of the coating agent, if needed, being added to the suspending medium together with the cyroground poly alpha olefin.

Other methods of grinding or forming particulate drag reducing polymer are disclosed in U.S. Pat. Nos. 6,894,088; 6,946,500; 7,271,205, and U.S. Publication 2006/0276566.

The drag reducing compositions of the present invention can also include a surfactant such as, for example, surfactants such as alkyl phenols, e.g., nonyl phenol or other surface active agents. In a preferred embodiment, the surfactant will have a HLB of greater than about 7, preferably greater than about 9. When a surfactant is employed, it will be present in an effective amount wherein an effective amount is defined as an amount sufficient to aid in dispersing the polymer in the suspending medium and/or disperse the modifier in the suspending medium. Additionally, it may be desirable in certain environments to incorporate a pour point depressant to ensure fluidity of the composition at very low temperatures.

The compositions of the present invention can also include emulsifiers to enhance miscibility between the fatty acid component and the modifier, particularly when the modifier is water or a polar organic liquid/water mixture. In this regard, the preferred polar organic components, e.g., alcohols and glycols, particularly alcohols and glycols with less than about 8 carbon atoms, generally have limited solubility in the fatty acid suspending medium. Accordingly, by using an emulsifier and in the particular case of these lower carbon atom alcohols and glycols, alone or with water, the emulsifying agent can provide a homogeneous or at least more homogeneous composition. When an emulsifier is employed, it will be present in an effective amount wherein an effective amount is defined as an amount sufficient to form a homogeneous or largely homogeneous composition comprising the drag reducing polymer, the suspending medium and the modifier.

As noted above, the effect of the addition of a modifier, e.g., a polar organic compound, to the suspending medium which is primarily comprised of fatty acids component retards settling of the polymer particles. Although the exact mechanism behind this phenomena is not known, it is postulated that the modifiers, particularly the polar organic compounds, prevent agglomeration of the polymer particles with the consequence that less settling or polymer separation of the polymer particles from the suspending medium occurs.

The stable, non-agglomerating compositions of the present invention flow easily and can be readily injected into a pipeline or conduit containing flowing hydrocarbons without any special equipment. Generally, the drag reducing compositions of the present invention can be added to the flowing hydrocarbon fluid by continuous injection by means of proportioning pumps situated at desired locations along the conduit in which the hydrocarbon is flowing.

The hydrocarbon fluids in which friction loss may be reduced by addition of the drag reducing compositions of the present invention include such materials as crude oils, gas oils, diesel oils, fuel oils, refined liquid hydrocarbon stream, asphaltic oils, and the like, varying from materials with relatively low viscosity, pure materials to high viscosity hydrocarbon containing fractions.

The amount of the polyolefin friction-reducing agent used for reducing drag in a pipeline or conduit is usually expressed as ppm (parts by weight of polymer per million parts by weight of hydrocarbon fluid). The amount of a polyolefin friction reducing agent required to produce the desired drag reduction will vary depending upon the physical properties and composition of the hydrocarbon fluid. Thus, the desired result may be obtained by the addition of as little as two ppm or less of the polymer. Conversely, some high viscosity fluids may require as much as 1,000 ppm or even up to 10,000 ppm of the polyolefin friction reducing agent to achieve desired drag reduction. Generally, it is preferred to add the polyolefin friction reducing agent in amounts of from about 2 to about 500 ppm and most preferably amounts from about 1 to about 100 ppm.

The drag reducing compositions of the present invention provide a number of advantages. For one, the composition can easily be injected in the pipeline without any special equipment such as special nozzles or placement of nozzles. The compositions of the present invention readily dissolve in the flowing hydrocarbon. Lastly, the compositions of the present invention can be used with a much higher loading of the polyolefin friction reducing agent, polymer contents of up to 45% by weight or more forming stable, free flowing compositions. It will be recognized that this substantially reduces transportation costs as the shipping volume of the friction reducing composition is substantially less. Additionally, the molecular weight of the polyolefin friction reducing agent in the composition can be substantially increased without handling problems associated with conventional polymer solutions. As noted above, with increased molecular weight, the effective performance of a polyolefin friction reducing agent is improved. Since the suspending medium can take the form of a vegetable oil, environmental hazards both in transportation and in use of the composition are greatly reduced.

Three samples, Sample A, Sample B, and Sample C were prepared. The compositions of the samples are shown in the table below.

| Wt. % | Sample A | Sample B | Sample C |
|---|---|---|---|
| Polyolefin¹ | 40 | 40 | 40 |
| Soybean Oil | 60 | | 59 |
| Denatured alcohol | | 60 | 1 |
| (ethanol) | | | |

¹Coated with polyethylene wax

The samples were prepared by mixing the components together with vigorous shaking. Each of the samples was then allowed to remain quiescent for a period of one week. After the one week period, it was noticed that Sample A had a well defined, clean layer of soybean oil at the bottom and a milky suspension of polymer particles and soybean oil at the top. Sample B had a clear layer of denatured alcohol at the top and a substantially solid layer of polymer particles at the bottom. Sample C had a cloudy bottom layer which was a mixture of suspending medium, modifier and some polymer and an upper layer of suspending medium and polymer. As can be seen from the above, with the addition of the denatured alcohol, while there is some separation into two layers, unlike the cases of Sample A and Sample B wherein in Sample A the bottom layer was clear, soybean oil and in Sample B the upper layer was clear denatured alcohol, in Sample C the bottom layer was quite milky and contained significant amounts of polymer particles dispersed therein. The results demonstrate that by the addition of a relatively small amount of a modifier as defined above, e.g., an oxygenated, polar organic compound, in this case, denatured alcohol, a composition can be made which remains largely homogeneous for extended periods of time.

The foregoing description and examples illustrate selected embodiments of the present invention. In light thereof, variations and modifications will be suggested to one skilled in the art, all of which are in the spirit and purview of this invention.

What is claimed is:

1. A drag reducing composition comprising:
from about 10 to about 70% by weight of a finely divided solid polyolefin, friction-reducing agent formed from mono olefins containing from 2 to 30 carbon atoms;
from about 10 to about 65% by weight of a fatty acid suspending medium; and
from about 0.1 to about 80% by weight of a modifier selected from the group consisting of an oxygenated, polar organic compound, water and mixtures thereof.

2. The composition of claim 1 wherein said suspending medium comprises a vegetable oil.

3. The composition of claim 2 wherein said vegetable oil comprises soybean oil.

4. The composition of claim 1 wherein said polyolefin friction reducing agent is produced by solution polymerization.

5. The composition of claim 1 wherein said polyolefin friction-reducing agent is produced by bulk polymerization.

6. The composition of claim 1 further including from 0.1 to 25% by weight of a coating agent.

7. The composition of claim 6 wherein said coating agent comprises a wax.

8. The composition of claim 7 wherein said wax is a hydrocarbon wax.

9. The composition of claim 1 wherein said oxygenated, polar organic compound contains from about 1 to about 20 carbon atoms.

10. The composition of claim 9 wherein said polar organic compound is selected from the group consisting of alcohols and glycols containing from 1 to 14 carbon atoms, water and mixtures thereof.

11. The composition of claim 1 further including an effective amount of a surfactant.

12. The composition of claim 1 further including an effective amount of an emulsifier.

13. A method of forming a drag reducing composition comprising:
finely dividing a solid polyolefin friction reducing agent formed from mono olefins containing from 2 to 30 carbon atoms to produce a free flowing, particulate polyolefin material; and
suspending said particulate polyolefin material in a mixture comprising a fatty acid suspending medium and a modifier comprising an oxygenated polar organic compound, water or mixtures thereof.

14. The method of claim 13 wherein said polyolefin friction reducing agent is finely divided by cyrogrinding.

15. The method of claim 14 wherein said cyrogrinding is conducted in the presence of a coating agent.

16. The method of claim 15 wherein said coating agent comprises a wax.

17. The method of claim 15 wherein said wax comprises a hydrocarbon wax.

18. The method of claim 13 wherein the coating agent is added to said suspending medium after said cyrogrinding.

19. The method of claim 1 wherein said oxygenated polar organic compound is selected from the group consisting of alcohols and glycols containing from 1 to 14 carbon atoms, water and mixtures thereof.

20. The method of claim 13 further comprising including an effective amount of an emulsifier.

21. A method of reducing drag in a conduit conveying a liquid containing a hydrocarbon comprising introducing into said conduit an effective amount of the composition of claim 1.

22. The method of claim 13 wherein the amount of said composition introduced into said conduit provides from 1 to 100 ppm of said polyolefin friction reducing agent in said liquid hydrocarbon.
